(19) United States
(12) Patent Application Publication
(10) Pub. No.: US 2016/0068654 A1
(43) Pub. Date: Mar. 10, 2016

(54) Electrospinning solution Composition for Preparing Silver Nanofiber

(71) Applicant: KOREA INSTITUTE OF INDUSTRIAL TECHNOLOGY, Chungcheongnam-do (KR)

(72) Inventors: Hoon HUH, Seoul (KR); Woo Sik KIM, Incheon (KR); Suk Hoon CHOI, Gwangju (KR)

(73) Assignee: KOREA INSTITUTE OF INDUSTRIAL TECHNOLOGY, Ceonan (KR)

(21) Appl. No.: 14/787,289

(22) PCT Filed: Mar. 21, 2014
(86) PCT No.: PCT/KR2014/002380

§ 371 Date: Oct. 27, 2015

(30) Foreign Application Priority Data
Apr. 29, 2013 (KR) 10-2013-0047140

(51) Int. Cl. C08K 3/28; C08L 33/02; C08L 39/06

(52) U.S. Cl. CPC C08K 3/28; C08L 39/06; C08L 33/02

(57) ABSTRACT

The present invention relates to an electrospinning solution composition for fabricating a silver nanofiber, and more particularly to an electrospinning solution composition for fabricating a silver nanofiber through a spinning process, the electrospinning solution including a silver precursor, a reducing agent, a viscosity modifier, and a solvent wherein the viscosity modifier includes one selected from the group consisting of dextran, alginate, chitosan, guar gum, starch, carboxymethyl cellulose, hydroxyethyl cellulose, hydroxypropyl methylcellulose, xanthan gum, a carboxyvinyl polymer, pectin, sodium alginate, and a combination thereof.

According to the present invention, a viscosity suitable for spinning is maintained by using a viscosity modifier to be able to improve quality of a silver nanofiber.

### TECHNICAL FIELD

The present invention relates to an electrospinning solution composition for fabricating a silver nanofiber, the electrospinning solution composition maintaining a viscosity suitable for electrospinning to be able to improve quality of the silver nanofiber.

### BACKGROUND ART

Nanotechnology techniques identify and control properties of a material in a nanometer level and thus physically and chemically control a material in a molecule or an atomic level to realize useful structure and function.

Since nanotechnology materials represent very different properties from the existing art materials, various studies to develop a new device in nano size are actively conducted in all academic fields such as physics, chemistry, materials, electricity, electronics, etc.

For example, since a device using a metal nanostructure may be applied to make an electronic device, an optical device, an optoelectronic device, an electronic device, or a device and catalyst for detecting a bio-active molecule which is highly efficient and is difficult to be realized in bulk devices made by an existing art, worldwide researches on synthesis and property of the device using a metal nanostructure are being actively performed.

Since nanofiber among nano materials is a very thin fiber having a thickness of less than one thousandth of an existing fiber, most of a surface thereof is in contact with air and the nanofiber has different properties such as high specific surface area and flexibility, from the existing fiber.

Since the nanofiber is a high performance material applicable to whole industries, applications of a nanomaterial to a nonwoven fabric filter, miniaturization and high functionalization of an electronic device, and a living tissue are increasing and applications of a nanomaterial for high functionalization in a traditional industry such as machinery and chemistry industries are increasing day by day.

Differently from before, the nanofiber is spotlighted as a material supporting a cutting edge industry such as IT, biotechnology, and environmental industries, for example, an environmental material: a lightweight protective clothing with excellent explosion-proof; an engine filter; or a filter for a next generation clean room, an IT-related material: a secondary battery separator; an electrode material; and a sensor tip, and a bio-related material: a scaffold for regenerative medicine, in addition to being used as a fiber itself.

Nanofibers may be classified into polymer nanofibers, carbon nanofibers, ceramic nanofibers, metal nanofibers, and the like according to materials thereof, and are fabricated by any one of a composite spinning method, a melt blow method, a CVD method, a biological method, and the like in addition to an electrospinning.

In particular, there have been various attempts for fabricating a metal nanofiber through the electrospinning. That is, when the electrospinning technology is used, a nanofiber with a diameter of several nm to several um may be easily fabricated, and at this time, properties of the metal nanofiber may be controlled according to the composition of a spinning solution, the spinning condition, the type of a precursor, and the heat treatment condition.

Korea patent publication No. 2010-0038979 discloses a platinum-based nanofiber which may be usefully used as an opto-electronic device and a sensing device, and also discloses a method of fabricating a platinum-based nanofiber by mixing a platinum-containing precursor, a polymer compatible with the precursor, and a solvent together to prepare a metal precursor solution; electrospinning the metal precursor solution to fabricate a composite nanofiber mixed with a metal precursor and a polymer; and heat-treating the composite nanofiber to remove the polymer from the composite nanofiber.

Korea patent publication No. 2011-0072805 discloses a nanofiber having a micro pore with an average pore diameter of 0.1 to 20 nm and having a porosity per unit volume ranging from 0.01 to 10% wherein the nanofiber is fabricated by performing an electrospinning and then heat-treating.

Korea patent publication No. 2013-0030987 discloses a method of fabricating a magnetic nano-fiber through an electrospinning wherein a fine grain may be controlled by performing an electrospinning and then oxidizing and deoxygenating the nanofiber.

### DISCLOSURE OF THE INVENTION

### Technical Problem

The present inventors have employed an electrospinning process for fabricating a silver nanofiber to confirm viscosity of a spinning solution to be a parameter affecting the quality of the nanofiber and have established that a high quality silver nanofiber with a smooth surface may be fabricated by using a specific viscosity modifier as a composition of the spinning solution, thus completing the present invention.

Therefore, the present invention has an object to provide a high quality electrospinning solution composition for fabricating a silver nanofiber.

### Technical Solution

In order to achieve the above object, the present invention provides an electrospinning solution composition for fabricating a silver nanofiber, the electrospinning solution including a silver precursor, a reducing agent, a viscosity modifier, and a solvent wherein the viscosity modifier is one selected from the group consisting of dextran, alginate, chitosan, guar gum, starch, carboxymethyl cellulose, hydroxyethyl cellulose, hydroxypropyl methylcellulose, xanthan gum, a carboxyvinyl polymer, pectin, sodium alginate, and a combination thereof.

### Advantageous Effects

A viscosity suitable for spinning is maintained by using a viscosity modifier according to the present invention to be able to improve the quality of a silver nanofiber.

### BRIEF DESCRIPTION OF THE DRAWINGS

FIG. 1 shows a scanning electron microscope image showing a silver nanofiber fabricated by Example 1.

### MODE FOR CARRYING OUT THE INVENTION

Hereinafter, the present invention will be described in more detail.

A silver nanofiber through a spinning is fabricated by a reaction of a silver precursor and a reducing agent and then a heat treatment and in this regard, upon removal of a solvent and a fibrous polymer by the heat treatment, shrinkage or cracking occurs to destruct the silver nanofiber, thus degrading the quality thereof. The quality of a silver nanofiber is influenced by a variety of parameters and in particular, by viscosity of a spinning solution used in order to facilitate fiberizing. Therefore, the present invention proposes a spinning solution composition being able to improve the quality of a silver nanofiber.

A composition for fabricating a silver nanofiber includes a silver precursor, a reducing agent, and a solvent and in particular, the present invention is characterized by using a viscosity modifier in order to facilitate fiberizing.

The available viscosity modifier is one selected from the group consisting of dextran, alginate, chitosan, guar gum, starch, carboxymethyl cellulose, hydroxyethyl cellulose, hydroxypropyl methylcellulose, xanthan gum, a carboxyvinyl polymer, pectin, sodium alginate, and a combination thereof.

The viscosity of the spinning solution composition is prepared in a range of 20 to 200,000 cP, preferably in a range of 110 to 200 cp by using the viscosity modifier.

As described above, the spinning solution composition for fabricating a silver nanofiber includes a silver precursor, a reducing agent, and a solvent.

The silver precursor may be a nitrogen oxide, nitride, halide, alkoxide, a cyanine, a sulfide, an amide, a cyanide, hydride, peroxide, porphine, a hydrate, a hydroxide, or an esterified product. Preferably, the silver precursor may be silver nitrate (AgNO₃), silver nitrate (AgNO₂), silver acetate (CH₃COOAg), silver lactate (CH₃CH(OH)COOAg), a citric acid silver hydrate (AgO₂CCH₂C(OH) (CO₂Ag)CH₂CO₂Ag.xH₂O. In an embodiment of the present invention, silver nitride is used as a precursor in order to fabricate a silver nanofiber.

The reducing agent is used to reduce a silver precursor to silver and may include one selected from the group consisting of hydrazine, potassium borohydride, sodium borohydride, potassium hydroquinonemonosulfonate, hydroxy amine, sodium pyrophosphate, sorbitol, pyrocatechol, catechol, and a combination thereof.

The reducing agent is used in an amount of 0.01 to 10.0 parts by weight with respect to 100 parts by weight of the silver precursor. When the content of the reducing agent is less than the above range, silver is not sufficiently reduced so that yield is lowered, and, on contrary, when the content of the reducing agent is more than the above range, excessive use of the reducing agent increases only a cost without significant improvement on a reducing action.

A solvent that is available in the present invention is not particularly limited if the solvent is able to dissolve the silver precursor and the viscosity modifier, and may be a polar or a non-polar solvent. As a specific example, the solvent includes one selected from the group consisting of water, ethanol, isopropanol, N,N-dimethylformamide (DMF), dimethylacetamide (DMAc), tetrahydrofuran (THF), dimethylsulfoxide (DMSO), gamma butyrolactone, N-methylpyrrolidone, chloroform, toluene, acetone, and a combination thereof.

At this time, the content of the solvent is determined so that the concentration of the spinning solution ranges from 0.1 to 40 wt %. When the concentration is less than the above range, process time is extended and on contrary, when the concentration is more than the above range, a nozzle has a risk of being clogged.

When necessary, a variety of commercially available additives such as a capping agent, a dispersant, a surfactant, and an antioxidant may be used.

The capping agent is selectively absorbed into a particular surface of a crystal to play a role of suppressing crystal growth of the surface, thus, as a result, being used to allow a silver nanofiber with a great aspect ratio to be fabricated, to prevent the nanofiber from being aggregated from each other, and to prevent a surface from being oxidized. Therefore, the capping agent may be a compound having an amine group or a carboxyl group, and in the present invention, a polymer capping agent is used as a material for giving viscosity to the spinning solution in electrospinning and forming a fiber phase in spinning.

Typically, the polymer capping agent be one selected from the group consisting of polyvinylpyrrolidone (PVP), polyethylene oxide (PEO), polyvinyl alcohol (PVA), polyvinylidene fluoride (PVDF), polyvinyl acetate (PVAc) polyacrylonitrile (PAN), polyamide (PA), polyacrylamide (PAA), polyurethane (PU), poly (etherimide) (PEI), polybenzimidazole (PBI), and a combination thereof. In an embodiment of the present invention, polyvinylpyrrolidone is used as the polymer capping agent.

At this time, the polymer capping agent with a weight average molecular weight of 500,000 to 2,000,000 is used in order to fully perform a role of the capping agent

The capping agent is used in an amount of 1 to 50 parts by weight with respect to 100 parts by weight of the silver precursor. When an amount of the capping agent is excessively used, the silver nanofiber is not formed well after a heat treatment.

The spinning solution composition according to the present invention may fabricate a silver nanofiber through a spinning process and a heat treatment.

At this time, the spinning process is not particularly limited in the present invention but is a publicly known electrospinning process, and the spinning process fabricates an ultra fine fiber with a diameter of 10 to 1000nm, preferably 50 to 500nm, and more preferably 100 to 300 nm.

Then, the ultra fine fiber is heat treated at 100 to 500° C. to fabricate a silver nanofiber.

The silver nanofiber fabricated through the above steps has a diameter ranging from 50 to 200 nm and a relatively high aspect ratio ranging from 100 to 1000. The fabricated silver nanofiber may be applied to a variety of fields, i.e., tissue engineering, a drug delivery, a membrane, a filter, a battery, chemical and bio sensors, and the like.

Hereinafter, the present invention will be described in more detail with reference to examples. These examples are only to illustrate the present invention in more detail, and the scope of the present invention is not construed as being limited by these examples is apparent to those skilled in the art.

### EXAMPLE AND COMPARATIVE EXAMPLE

### Fabrication of a Spinning Solution Composition

(1) Fabrication of Spinning Solution Composition

Nitrate, hydrazine, a viscosity modifier, and a capping agent were added to a mixed solvent (distilled water/ethanol, 4 mL/6 mL) in a composition of Table 1 to fabricate a spinning solution.

(2) Fabrication of Ultra Fine Fiber

The spinning solution was injected into a spinneret, then located in a syringe pump, and then fixed at a flow rate of 0.005 ml/h.

At this time, a collector and the spinneret were vertically positioned to each other and the collector was prepared by being configured with a conductive metal electrode in order to obtain an aligned ultra fine fiber. A distance between the collector and the spinneret was fixed to 15 cm and voltage level of 12 kV was applied thereto to fabricate the ultra fine fiber (diameter: 200-350 nm).

(3) Heat Treatment

A first heat treatment in which the ultra fine fiber was charged in a furnace, a temperature of the furnace was increased to 100° C. at a rate of 1° C./min under a reducing atmosphere (N₂/H₂, 80% by volume/20% by volume), and then was maintained for one hour, a second heat treatment in which a temperature of the furnace was increased to 200° C. at a rate of 1° C./min and then maintained for 30 minutes, and a third heat treatment in which a temperature of the furnace was increased to 300° C. at a rate of 1° C./min and then maintained for 3 hours were performed.

TABLE 1

| | | | | | | | | | | Comparative | | Comparative | | Comparative | |
|---|---|---|---|---|---|---|---|---|---|---|---|---|---|---|---|
| Content | | Example 1 | | Example 2 | | Example 3 | | Example 4 | | Example 1 | | Example 2 | | Example 3 | |
| Silver | Nitrate | 3.0 | g | 3.0 | g | 3.0 | g | 3.0 | g | 3.0 | g | 3.0 | g | 3.0 | g |
| precursor | salt | | | | | | | | | | | | | | |
| Reducing | Hydrazine | 0.05 | g | 0.05 | g | 0.05 | g | 0.05 | g | 0.05 | g | 0.05 | g | 0.05 | g |
| agent | | | | | | | | | | | | | | | |
| Solvent | Ethanol/ | 10 | mL | 10 | mL | 10 | mL | 10 | mL | 10 | mL | 10 | mL | 10 | mL |
| | water | | | | | | | | | | | | | | |

| | | | | | | | | | | |
|---|---|---|---|---|---|---|---|---|---|---|
| Dextran | 0.5 | g | — | — | — | 0.01 | g | 3.0 | g | — |

| | | | | | | | | | |
|---|---|---|---|---|---|---|---|---|---|
| Viscosity | Guar gum | — | 0.5 | g | — | — | — | — | — |

| | | | | | | | | | |
|---|---|---|---|---|---|---|---|---|---|
| Modifier | Hydroxyethyl | — | — | 0.5 | g | — | — | — | — |
| | cellulose | | | | | | | | |

| | | | | | | | | | |
|---|---|---|---|---|---|---|---|---|---|
| | Polyacrylic | — | — | — | 0.5 | g | — | — | — |
| | acid | | | | | | | | |
| Capping | PVP | — | — | — | 0.1 | g | — | — | — |
| agent | (MW = 300,000) | | | | | | | | |

| | | | | | | | | |
|---|---|---|---|---|---|---|---|---|
| PVP | — | — | — | — | — | — | 0.5 | g |
| (MW = 1,300,000) | | | | | | | | |

| | | | | | | | |
|---|---|---|---|---|---|---|---|
| Viscosity (cP) | 130 | 125 | 130 | 137 | 100 | 300 | 130 |

### Experimental Example 1

The silver nanofibers fabricated in compositions of above Examples and Comparative Examples were measured by a scanning electron microscope to check sizes and qualities thereof and then the results are shown in Table 2 below.

TABLE 2

| | | | | | Comparative | Comparative | Comparative |
|---|---|---|---|---|---|---|---|
| | Example 1 | Example 2 | Example 3 | Example 4 | Example 1 | Example 2 | Example 3 |
| Diameter | 100-150 nm | 100-150 nm | 100-150 nm | 120-150 nm | 50-250 nm | 200-400 nm | 100-200 nm |
| Quality | Good | Good | Good | Good | Bad | Bad | Good |

Referring to Table 2, it was confirmed that silver nanofibers fabricated in Embodiments 1 to 4 according to the present invention had diameters ranging from 100 to 200 nm and surfaces of the silver nanofibers were smooth.

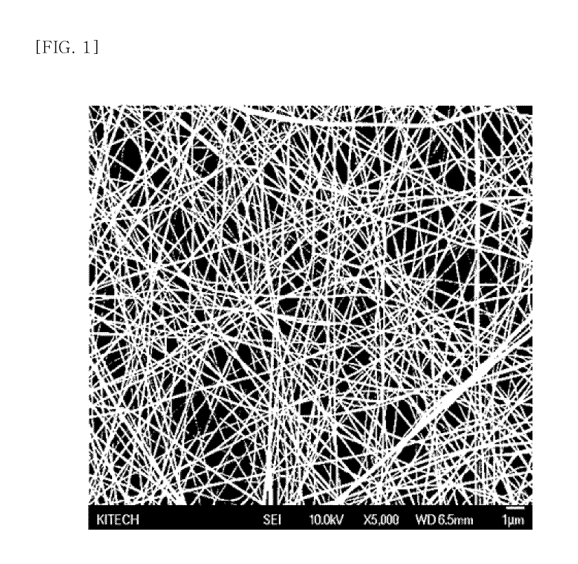

FIG. 1 shows a scanning electron microscope (SEM, ×5,000) picture of the silver nanofiber fabricated by Example 1. It could be confirmed from FIG. 1 that a silver nanofiber with a diameter ranging from 100 to 150 nm was formed.

In comparison, it was confirmed that the silver nanofiber in Comparative Example 1 was thin due to low viscosity but did not have a constant thickness and the silver nanofiber in Comparative Example 2 was thick due to high viscosity and had a rugged surface.

In addition, in Comparative Example 3 in which PVP was used, good quality of a silver nanofiber was obtained.

1. An electrospinning solution composition for fabricating a silver nanofiber, the electrospinning solution composition comprising: a silver precursor, a reducing agent, a viscosity modifier, and a solvent for fabricating a nanofiber through a spinning process, wherein the viscosity modifier is one selected from the group consisting of dextran, alginate, chitosan, guar gum, starch, carboxymethyl cellulose, hydroxyethyl cellulose, hydroxypropyl methylcellulose, xanthan gum, a carboxyvinyl polymer, pectin, sodium alginate, and a combination thereof.

2. The electrospinning solution composition of claim 1, wherein the viscosity modifier is contained in an amount of 1.0 to 10 wt % with respect to the total weight of the composition.

3. The electrospinning solution composition of claim 1, wherein the silver precursor comprises one selected from the group consisting of silver nitrate (AgNO₃), silver nitrate (AgNO₂), silver acetate (CH₃COOAg), silver lactate (CH₃CH(OH)COOAg), a citric acid silver hydrate (AgO2CCH₂C(OH)(CO₂Ag)CH₂CO₂Ag.xH₂O), and a combination thereof.

4. The electrospinning solution composition of claim 1, wherein the reducing agent comprises one selected from the group consisting of hydrazine, potassium borohydride, sodium borohydride, potassium hydroquinonemonosulfonate, hydroxy amine, sodium pyrophosphate, sorbitol, pyrocatechol, catechol, and a combination thereof.

5. The electrospinning solution composition of claim 1, wherein the solvent comprises one selected from the group consisting of water, ethanol, isopropanol, N,N-dimethylformamide (DMF), dimethylacetamide (DMAc), tetrahydrofuran (THF), dimethylsulfoxide (DMSO), gamma butyrolactone, N-methylpyrrolidone, chloroform, toluene, acetone, and a combination thereof.

6. The electrospinning solution composition of claim 1, wherein the electrospinning solution composition has a concentration ranging from 0.1 to 40 wt %.

7. The electrospinning solution composition of claim 1, wherein the electrospinning solution composition has a viscosity ranging from 20 to 200,000 cP.

8. The electrospinning solution composition of claim 1, wherein the electrospinning solution composition further comprises one selected from the group consisting of a capping agent, a dispersant, a surfactant, an antioxidant, and a combination thereof.

9. The electrospinning solution composition of claim 8, wherein the capping agent comprises one selected from the group consisting of polyvinylpyrrolidone (PVP), polyethylene oxide (PEO), polyvinyl alcohol (PVA), polyvinylidene fluoride (PVDF), polyvinyl acetate (PVAc) polyacrylonitrile (PAN), polyamide (PA), polyacrylamide (PAA), polyurethane (PU), poly (etherimide) (PEI), polybenzimidazole (PBI), cetyltrimethylammonium bromide (CTAB), cetyltrimethylammonium chloride (CTAC), and a combination thereof.
